(19) United States
(12) Patent Application Publication
(10) Pub. No.: US 2023/0091445 A1
(43) Pub. Date: Mar. 23, 2023

(54) Coil Impregnation With Filled Resin

(71) Applicant: Siemens Healthcare Limited, Camberley (GB)

(72) Inventor: Simon James Calvert, Chipping Norton (GB)

(73) Assignee: Siemens Healthcare Limited, Camberley (GB)

(21) Appl. No.: 17/950,241

(22) Filed: Sep. 22, 2022

(30) Foreign Application Priority Data
Sep. 23, 2021 (GB) 2113576.9

(51) Int. Cl. H01F 41/00; B29C 45/14

(52) U.S. Cl. CPC H01F 41/005; B29C 45/14008; B29C 45/14549; B29C 2045/14057; B29L 2031/34

(57) ABSTRACT

Techniques are described for a method to manufacture a magnet structure comprising superconducting coils and annular spacers comprising a filled composite filler material. Also described are superconducting magnet structures as may be manufactured by such a method.

### CROSS-REFERENCE TO RELATED APPLICATIONS

The present application claims priority to and the benefit of United Kingdom patent application no. GB 2113576.9, filed on Sep. 23, 2021, the contents of which are incorporated herein by reference in its entirety.

### TECHNICAL FIELD

The present disclosure relates to methods of manufacturing multi-coil cylindrical superconducting magnets, and to cylindrical superconducting magnets as may be manufactured by such methods. Such magnets may be employed as a main magnetic field generator in a magnetic resonance imaging (MRI) system.

### BACKGROUND

Conventionally, cylindrical superconducting magnets have been manufactured with “formers,” or with external sleeves. Recent “formerless” magnets, composed of alternating annular coils and annular spacers, are generally known. The present disclosure aims to provide simpler, more reliable manufacturing methods for manufacturing superconducting magnets, and to provide improved superconducting magnets as may be manufactured by such methods.

### SUMMARY

Certain multi-coil formerless superconducting magnets are generally known, and may for example be known as “serially bonded magnets” or “SBM.” SBM magnets can be assembled using individual coils stacked with preformed annular spacers, but such methods result in long manufacturing times, and manufacturing tolerances “stack up” in the magnet assembly, making this approach potentially unsuitable for volume-manufactured magnets. The use of preformed annular spacers significantly increases the cost of the magnet, as such spacers must be accurately machined.

The present disclosure accordingly seeks to provide methods of manufacturing multi-coil superconducting magnets that are simpler and more precise than known methods, and may be employed at a reduced cost compared to known methods. The present disclosure also provides multi-coil superconducting magnets as may be produced by such methods.

The present disclosure aims to provide a multi-coil superconducting magnet. The inner diameter of individual coils can be slightly increased, even while maintaining a constant or slightly tapered inner diameter of the structure as a whole, by adding layers of glass fiber cloth, or similar, onto a mandrel before the coil is wound onto those layers of cloth. This technique may be useful to achieve the required homogeneity while optimizing the amount of wire required. This is particularly useful in manufacturing parallel SBM magnets but other non-parallel designs can also be realized using this technique.

### BRIEF DESCRIPTION OF THE DRAWINGS

The above, and further objects, characteristics, and advantages of the present disclosure will become more apparent from the following discussion of certain embodiments thereof, given by way of non-limiting examples, in conjunction with the accompanying drawings, wherein:

FIG. 1 illustrates a stage in an example method of the present disclosure, where winding cheeks have been provided to define coil regions and spacer regions, in accordance with one or more embodiments of the present disclosure;

FIGS. 2-3 illustrate steps in respective example impregnation methods, in accordance with one or more embodiments of the present disclosure;

FIG. 4 illustrates an example resin-impregnated superconducting coil structure, as may result from a method in accordance with one or more embodiments of the present disclosure;

FIG. 5 illustrates an example coil winding step, in which interleaving is included between layers of wire to ensure that filled resin can impregnate the coil, in accordance with one or more embodiments of the present disclosure;

FIG. 6 illustrates an example alternative type of superconducting wire that may be used to wind coils rather than interleaving, in which the wire is indented during manufacture to ensure that filled resin can impregnate the coils, in accordance with one or more embodiments of the present disclosure;

FIG. 7 illustrates a schematic representation of another example alternative arrangement for providing permeability of wound superconducting coils by using helically wound woven glass or plastic tape, in accordance with one or more embodiments of the present disclosure; and

FIG. 8 illustrates an example in which layers of cloth are applied to the mandrel prior to winding of a coil so as to increase the diameter of the coil without requiring a variance in the diameter of the mandrel in accordance with one or more embodiments of the present disclosure.

### DETAILED DESCRIPTION OF THE DISCLOSURE

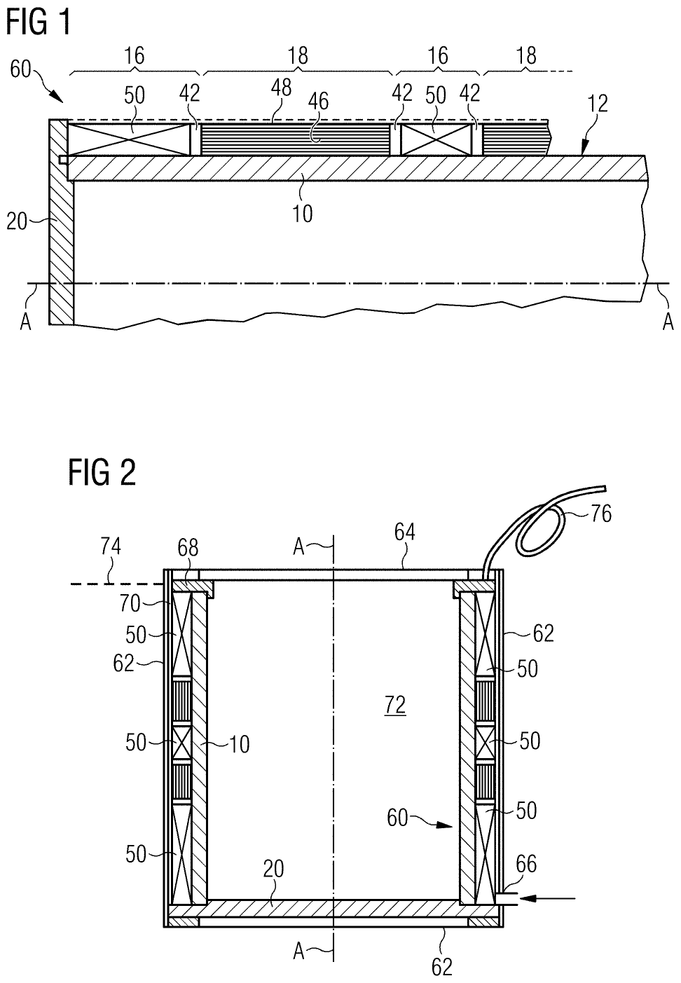

FIG. 1 illustrates a stage in an example method of the present disclosure. Here, winding cheeks 42 have been provided on an outer surface 12 of a mandrel 10 to define coil regions 16 and spacer regions 18. Winding cheeks 42 are an optional component, which may improve the accuracy of the coil 50 dimensions. As more clearly shown in FIG. 5, the winding cheeks 42 provide a continuous or near-continuous surface to define axial extremities of a winding cavity in coil regions 16, into which superconducting wire 44 is wound, to form respective superconducting coils 50. The winding cheeks 42 may be of a composite material such as Glass-Reinforced Plastic (GRP), or other plastic injection molded material that is low-cost and structurally stable over the range of temperatures and pressures that the winding cheeks 42 are likely to be subjected to. The winding cheeks 42 may be formed as complete annuli and slid onto mandrel 10. Alternatively, the winding cheeks 42 may be formed as arcs and assembled together circumferentially around the radially outer surface 12 of the mandrel 10. When composed of several arcs, the arcs need to be retained in position, for example by attachment to one another. The winding cheeks 42 are held in place on the mandrel 10 by an appropriate means until the coils 50 have been wound or at least partially wound. During winding of coils 50, layers of wire 44 press against winding cheeks 42, and further retain the coils 50 in position.

In other embodiments, no winding cheeks 42 are provided, and the superconducting wire 44 is wound into coils 50 in coil regions 16 defined and retained by permeable filler material 46 such as wound glass fiber cloth, which will form a component of composite material spacers 19 in a finished structure.

Coil regions 16 are thereby filled, or at least substantially filled, with coils 50 wound of superconducting wire 44. Similarly, spacer regions 18 may be filled with a porous filler material 46. In the example as shown in FIG. 1, this may be achieved by winding strips of cloth filler material 46 around the mandrel 10 into spacer regions 18, between winding cheeks 42. Other methods may be used for filling spacer regions 18, as will be discussed further below.

A release cloth layer 48 may be wound over the coils 50 and any wound filler cloth 46. The release cloth layer 48 may be of any suitable material conventionally used for such purposes, such as a glass fiber cloth coated in polytetrafluoroethylene (PTFE). The release cloth 48 serves to define a boundary within which will become part of the structure of the final superconducting magnet assembly, and outside of which any impregnating resin will be removed as waste in a cleaning step as part of the manufacturing process.

The resultant structure as partially illustrated in FIG. 1 may be impregnated with resin, as is conventional in itself. However, the present disclosure provides novel and advantageous features in such impregnation.

FIG. 2 illustrates a step in an example impregnation method that may be employed in a method of the present disclosure. Structure 60, such as partially illustrated in FIG. 1, is placed within an open-topped cylindrical trough 62. In the illustrated arrangement, a complete end plate 20 is provided at one axial end of mandrel 10, while an alternative, annular end plate 68 is employed at the other axial end of the mandrel 10. The wall of the trough 62 is used as an outer molding tool, and may be of approximately a required shape of a final molding of the finished superconducting coil assembly to ensure that a minimum amount of resin is required for impregnation of the coil assembly structure.

A lid 64 may be provided to seal the top of the trough. A resin inlet port 66 is provided, to allow impregnating resin to be introduced into the trough 62. The mandrel 10 and end plate 20 may be used to define radially inner and lower limits of a cavity 70 for filling with resin. This will require the mandrel 10, the end plate 20, and the seal between them to be resin-tight. In such an embodiment, no resin will enter the axial bore 72 of the mandrel 10. As is conventional in itself, resin may be introduced under gravity, by a pump such as a peristaltic pump, or a vacuum is drawn within the trough 62, within at least cavity 70, and resin is drawn through port 66 to impregnate the magnet structure 60. In any case, resin is introduced into the trough 62 until it reaches a fill level 74, which is at least sufficient to immerse all coils 50 in the resin. The resin is then caused or allowed to cure at least into a gel state, and the resulting impregnated structure 60 is then removed from the trough 62. The trough 62 may be removed in sections. A conventional clean-up operation may then be performed, e.g. including removal of any resin radially outside of the coils 50 and filler material 46, for example by peeling away the release cloth 48. The release cloth 48 should be porous to the resin used for impregnation of coils and any filler material 46 used in the spacer regions 18. In some embodiments, release cloth layer 48 is not used.

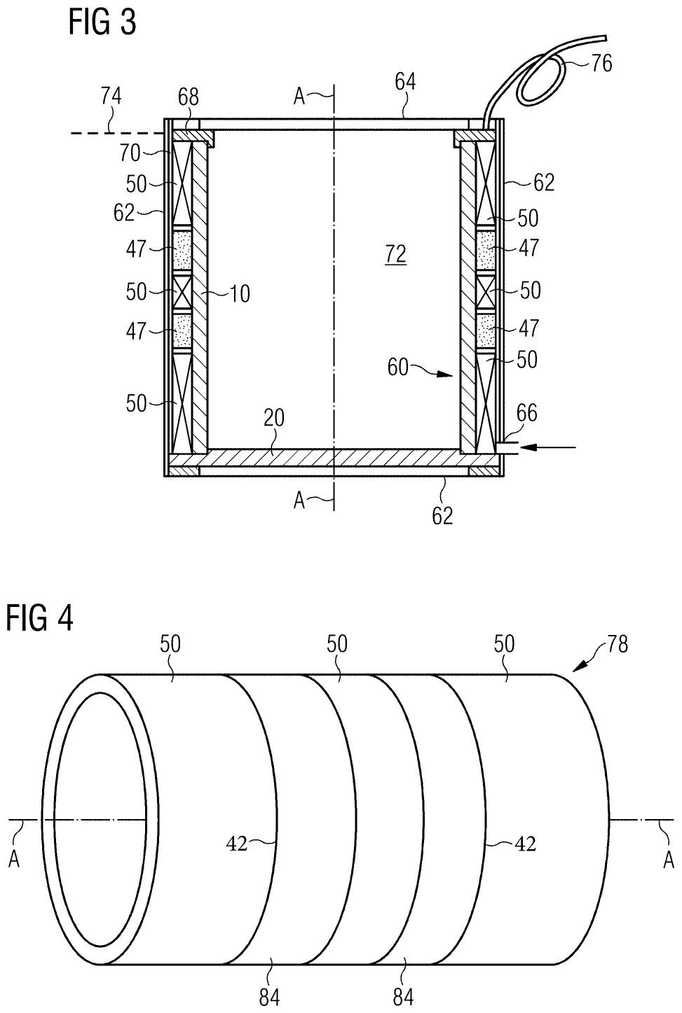

FIG. 3 illustrates an alternative embodiment in which coils 50 are wound into coil regions 16, but spacer regions 18 are left substantially empty. In such an embodiment, the resultant structure is placed into a trough 62, as in the arrangement of FIG. 2, but then dry loose filler material 47, such as dry glass spheres, sand, alumina, waste cured resin, or other thermally-stable low-cost material, is introduced into the trough 62 along with the structure 60. The dry loose filler material 47 should be introduced up to a fill level similar to resin fill level 74 shown in FIG. 2. The dry loose filler material 47 will occupy space between mandrel 10 and trough 62, particularly in spacer regions 18. As illustrated in FIG. 3, the trough 62 should preferably be of similar shape to the structure 60 to limit the quantity of dry loose filler material 47 and resin that is required to fill the cavity 70 up to about fill level 74. In an embodiment where axial regions 18 are filled with such dry loose filler material, it will not be possible to provide a release cloth layer 48 over the dry loose filler material in spacer regions 18. A release cloth layer 48 may still be provided over the coils 50 to remove any excess resin deposited radially outside of the coils 50 during the impregnation process.

Once the dry loose filler material 47 has been introduced up to about fill level 74, resin is introduced at least into cavity 70, either under gravity or by using a pump such as a peristaltic pump, or drawn by a vacuum. The resin permeates the dry loose filler material 47 to form composite material spacers 19. That resin is then caused or allowed to cure at least into a gel state, and the resulting impregnated structure is then removed from the trough 62. A conventional clean-up operation may then be performed, including removal of any resin radially outside of any release cloth layer 48.

In other embodiments, neither filler cloth nor dry loose filler material are used; rather, a filled resin is used for the impregnation step. Such filled resin may contain small particles of alumina, for example, and such filler provides improved mechanical strength and crack resistance. Of particular relevance in such embodiments, the wall of the trough 62 may be designed to optimize the shape of the final structure to minimize the amount of filled resin used while ensuring sufficient mechanical strength in the final structure, thereby reducing or eliminating the need for a clean-up step after molding.

FIG. 4 shows an example resin-impregnated superconducting coil structure 78, as may result from a method of the present disclosure. As shown in FIG. 4, the resin-impregnated superconducting coil structure 78 has been removed from the mandrel 10. This may be achieved by a mechanical press. A force of several tons may be required to displace the mandrel 10 from the superconducting coil structure 78. Removal may be aided by the provision of a release coating such as PTFE on the radially outer surface 12 of the mandrel 10. Removal may be further aided by providing the mandrel 10 with a slightly conical outer surface 12. Such a taper should only be slight, so as not to significantly increase the size of the resulting resin-impregnated superconducting coil structure 78. For example, the taper may be one degree or less, two degrees or less, five degrees or less, etc.

The embodiment shown in FIG. 4 may be made by the method described above in relation to FIG. 3, using a dry loose filler material 47. The dry loose filler material 47 may be impregnated with resin to form composite filler material 84.

According to certain embodiments of the present disclosure, as further described below, provision may be made for filled resin to be used for impregnation, and to penetrate between turns of the superconducting coils 50, and into dry filler material within spacer regions 18. Such arrangement may provide improved mechanical strength and increased crack resistance of the resulting coils.

In the example of FIG. 5, an axially-directed interleave material such as woven cords or tapes 86, for example of glass fiber, are provided between layers of windings of wire 44. The woven glass cords or tapes are placed at circumferential intervals, and provide axially-directed gaps 88 of sufficient size to allow filled resin to flow in directions 90 between layers of turns of wire 44. The interleave material 86 may consist of spaced axial fibers with some smaller hoop fibers to ensure the correct spacing of the axial fibers. This interleave material allows a filled resin to permeate the coils and to fill the gaps 88 between layers of windings making up the coils 50. Winding cheeks 42 are provided with perforations 43 to allow a flow of filled resin into and through the gaps 88. Such an arrangement will clearly increase the radial dimension of the resultant coil 50, but allows improved mechanical strength and crack resistance of the final structure to be achieved. In place of axially-directed woven cords or tapes 86, a woven mesh may be used, for example of glass- or carbon-fiber, e.g. with axially-directed rovings being rather thicker than circumferentially-directed rovings, to ensure sufficient space to allow passage of the filled resin.

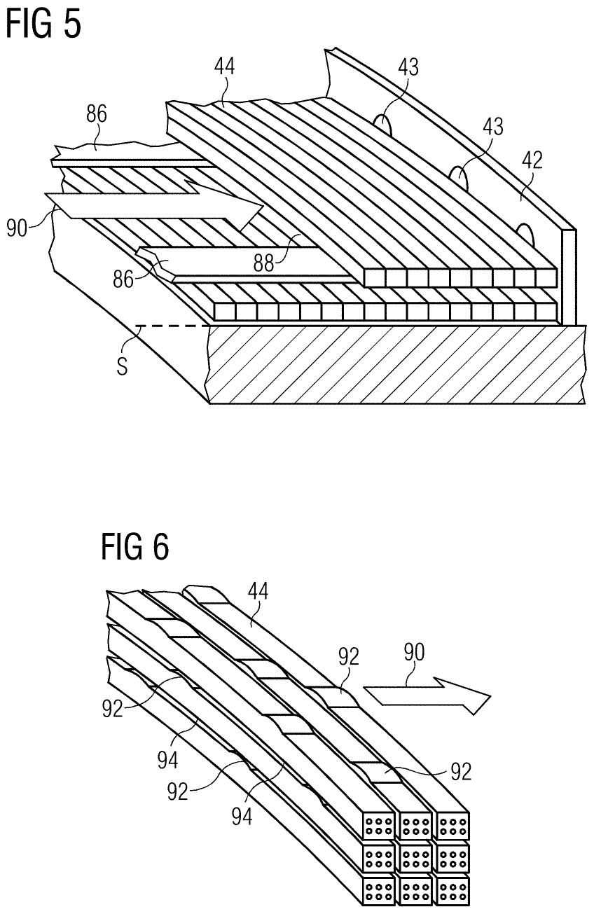

FIG. 6 schematically represents another embodiment that allows filled resin to penetrate between layers of coil windings. In this embodiment, the superconducting wire 44 is provided with embossed raised features 92 on at least one surface. These features may be created during manufacture of the wire 44. For example, the superconducting wire 44 may be pressed between rollers, at least one of which is provided with recesses in its surface, such that the wire 44 is provided with embossed raised features 92 as a result of such rolling. In the example shown in FIG. 6, the embossed raised features 92 are formed only on the surface of the wire that is wound into a radially outer position. Gaps 94 are accordingly formed, between layers of windings and between embossed raised features 92. Gaps 94 allow a filled resin to flow in axial directions 90 between layers of turns of wire 44. Such an arrangement will clearly increase the radial dimension of the resultant coil 50, but allows improved mechanical strength and crack resistance of the final structure to be achieved through use of a filled resin for impregnating the coils. In an alternative embodiment, wire 44 may be wound such that embossed raised features 92 are located on an axially-directed surface, and such that radially-directed gaps are formed, and that a filled resin may thereby flow in radial directions 90 between turns of wire 44. The wire 44 may be hard insulated, that is, coated with a solid electrically-insulating layer. This may e.g. be done after any rolling step to eliminate the possibility that such rolling may damage the electrically-insulating layer.

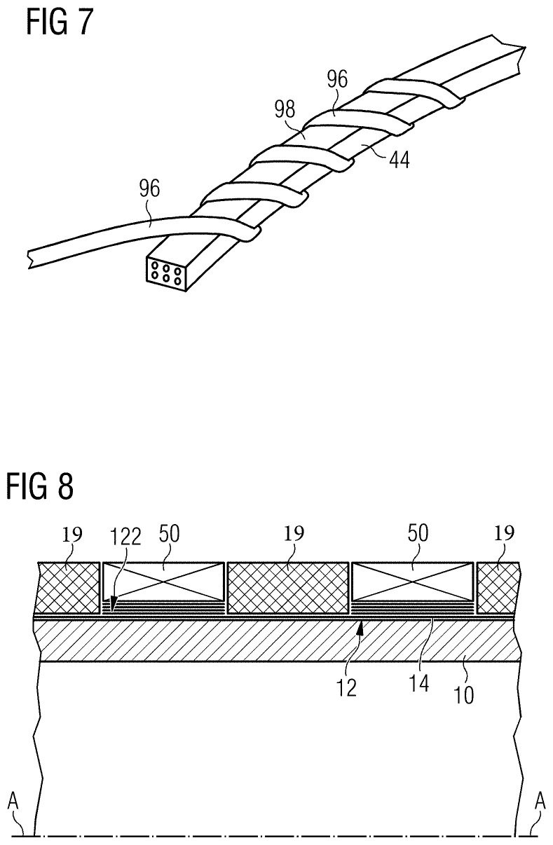

FIG. 7 schematically represents another alternative arrangement for providing permeability of wound superconducting coils to allow filled resin to permeate the coils. In this arrangement, superconducting wire 44 is part-lapped with an insulating material such as fiberglass, or plastic, tape 96. “Part-lapped” in this context means that the insulating material tape 96 is wound at such intervals that significant gaps 98 of exposed wire are left between adjacent turns. When such part-lapped wire is wound into coils 50, gaps 98 will provide radial and axial permeability for filled resin to permeate the resultant coil. This tape 96 can either be added during wire manufacture, or added as the wire is wound on the winding machine. The tape 96 can be wrapped by a rotating head prior to the coil being wound.

When impregnation and molding of the resultant superconducting magnet coil structure 60, 78 is complete, mandrel 10 is withdrawn from the resulting resin-impregnated superconducting magnet coil assembly.

Suitable filled resins may include some sold under the “LOCTITE”® “STYCAST”® brand. The filler material in such filled resins may be fine alumina particles; the material may have a particulate size small enough that the particles do not significantly impede penetration of the filled resin through gaps 88, 94. Such filled resins may be mechanically strong and thermally conductive.

Other resins suitable for use in cryogenic environments may alternatively be filled with alumina for use in methods of the present disclosure. The use of alumina-filled resin may also enable better distribution of heat energy during cooldown, warm-up, and during a quench of the superconducting magnet. Other filler materials that may be used instead of or in addition to alumina include sand, powdered stone, powdered glass, glass spheres, chopped glass fiber, chopped carbon fiber, etc.

FIG. 8 shows an example embodiment in which layers of cloth 122 are applied to the mandrel 10 prior to winding of a coil 50, so as to increase the diameter of the coil without requiring a variance in the diameter of the mandrel. The layers of cloth 122 may be wound dry and impregnated with resin during the same step that the coils are impregnated with resin. Similarly, the same effect may be achieved by winding a filament of glass fiber or similar, which may be wound dry and impregnated with resin during the same step that the coils are impregnated with resin. Once the cloth 122 or filament is wound to the required thickness over the mandrel 10 to provide the required inner diameter of the coil 50, wire 44 is wound over the cloth or filament to constitute a superconducting coil 50, in the same manner as the other coils as described above.

The use of filled resin as proposed in the present disclosure provides higher strength, improved thermal conductivity, and improved crack-resistance. thus leading to improved performance of the finished superconducting magnet structure. Alumina-filled resin is an ideal impregnation for “dry” or “low helium” magnets. as alumina-filled resin has good thermal conductivity. which enables a faster and more uniform cooldown.

Manufacture of superconducting coil assemblies by the methods proposed in the present disclosure may allow reductions in cost and time for manufacturing of resin-impregnated superconducting coil assemblies.

Moreover, the methods of the present disclosure do not require expensive, finely machined composite rings, formers, and sleeves, such as are employed in some conventional methods. The elimination of finely machined rings saves considerable material cost when manufacturing a superconducting magnet structure.

According to some embodiments of the present disclosure, the superconducting coil structure is molded, which enables the use of dry reinforcement material in the volumes between coils. These materials are much more cost-effective than the use of cured composites, as is conventional.

In superconducting magnet assemblies according to the present disclosure, the cold mass, i.e. the equipment that is held at a cryogenic temperature below the relevant superconducting transition temperature, in use, can be optimized to reduce material cost, labor hours, manufacturing lead-time, and logistics costs.

What is claimed is:

1. A method for manufacturing a superconducting magnet structure, comprising:
winding superconducting wire to form superconducting coils;
placing an assembly comprising the superconducting coils into a molding tool;
introducing a filled thermosetting resin into the molding tool to impregnate the superconducting coils thereby providing a resin-impregnated structure;
causing or allowing the filled thermosetting rein to cure; and
separating the resin-impregnated structure from the molding tool to provide the superconducting magnetic structure.

2. The method according to claim 1, further comprising:
providing axial sections between the superconducting coils,
wherein the act of introducing the filled thermosetting resin into the molding tool further comprises:
introducing the filled thermosetting resin into the axial sections; and
providing a composite filler material in the axial sections to form spacers as part of the resin-impregnated structure.

3. The method according to claim 1, further comprising:
providing a mandrel, wherein:
the act of winding the superconducting wire comprises winding the superconducting wire onto the mandrel in corresponding axial sections to form the superconducting coils, and
the act of placing the assembly into the molding tool comprises placing the assembly comprising the mandrel and the superconducting coils into the molding tool, and
the act of separating the resin-impregnated structure from the molding tool comprises removing the mandrel from the resin-impregnated structure.

4. The method according to claim 1, further comprising:
providing a former,
wherein the act of winding the superconducting wire comprises winding the superconducting wire into recesses of corresponding axial sections of the former to form the superconducting coils, thereby forming the assembly.

5. The method according to claim 3, further comprising:
providing empty axial sections for forming spacers on the mandrel alternately with the superconducting coils;
introducing, when the assembly is placed within the molding tool, dry loose filler material into the molding tool with the assembly to occupy the axial sections for forming the spacers; and
forming, when the filled thermosetting resin is introduced into the molding tool and caused or allowed to cure, the spacers of a composite material from the dry loose filler material and the filled thermosetting resin.

6. The method according to claim 5, wherein the dry loose filler material comprises one of alumina, sand, crushed glass, chopped glass fibers, chopped carbon fibers, waste cured resin, or glass balls.

7. The method according to claim 1, wherein the act of introducing the filled thermosetting resin into the molding tool comprises:
introducing a loose, dry filler material into the molding tool; and
introducing an unfilled resin into the molding tool to permeate the assembly and the dry loose filler material to thereby form the filled thermosetting resin.

8. The method according to claim 1, further comprising:
providing gaps between adjacent turns of the superconducting wire as the superconducting wire is wound such that the filled thermosetting resin permeates between the adjacent turns of the superconducting wire to thereby impregnate the superconducting coils.

9. The method according to claim 8, wherein the gaps are formed by axially-directed interleave material are provided at intervals between layers of windings of the superconducting wire.

10. The method according to claim 8, wherein the gaps are formed by embossed raised features on a surface of the superconducting wire.

11. The method according to claim 10, wherein the embossed raised features are formed only on a surface of the superconducting wire that is wound into a radially outer position, and
wherein the gaps are formed between layers of windings and between embossed raised features on the surface of the superconducting wire.

12. The method according to claim 10, wherein the embossed raised features are formed on the surface of the superconducting wire that is wound into an axially-directed position, and
wherein gaps are formed between windings of the superconducting wire and between the embossed raised features on the surface of the superconducting wire.

13. The method according to claim 8, wherein the superconducting wire is part-lapped with an insulating material tape such that superconducting coils include gaps between turns of the insulating material tape, and
wherein the gaps provide radial and axial permeability for the filled thermosetting resin.

14. A method for manufacturing a formerless, multi-coil cylindrical superconducting magnet structure, comprising:
providing a mandrel;
winding superconducting wire onto the mandrel in corresponding axial sections to form superconducting coils;
providing empty axial sections on the mandrel alternately with the superconducting coils to form spacers, thereby providing an assembly;
placing the assembly comprising the mandrel and the superconducting coils into a molding tool;
introducing dry loose filler material into the molding tool with the assembly to occupy the empty axial sections;
introducing a thermosetting resin into the molding tool to impregnate the superconducting coils and the dry loose filler material thereby providing a resin-impregnated structure;
causing or allowing the thermosetting resin to cure; and
removing the mandrel from the resin-impregnated structure to provide the formerless, multi-coil cylindrical superconducting magnet structure.

15. The method according to claim 14, wherein the dry loose filler material comprises one of alumina, sand, crushed glass, chopped glass fibers, chopped carbon fibers, waste cured resin, or glass balls.

16. A formerless, multi-coil cylindrical superconducting magnet structure, comprising:
superconducting coils; and
axial sections of spacers comprising a filler material, each one of the axial sections being provided between each one of the superconducting coils such that each one of the axial sections alternates with each one of the superconducting coils along a length of the formerless, multi-coil cylindrical superconducting magnet structure,
wherein the filler material and the superconducting coils are impregnated with a cured thermosetting resin.

17. The superconducting magnet structure according to claim 16, wherein the thermosetting resin comprises a filler material comprising one of alumina, sand, crushed glass, chopped glass fibers, chopped carbon fibers, waste cured resin, or glass balls.

18. The superconducting magnet structure according to claim 16, further comprising:
gaps filled with the cured thermosetting resin, the gaps being disposed between adjacent turns of superconducting wire of each one of the superconducting coils.

19. The superconducting magnet structure according to claim 18, wherein the gaps are formed by axially-directed interleave material provided at intervals between layers of windings of the superconducting wire of each of the superconducting coils.

20. The superconducting magnet structure according to claim 18, wherein the gaps are formed by embossed raised features on at least one surface of the superconducting wire of each one of the superconducting coils.

21. The superconducting magnet structure according to claim 20, wherein the embossed raised features are formed only on a surface of the superconducting wire that is wound into a radially outer position, and
wherein the gaps are formed between layers of windings of each one of the superconducting coils between the embossed raised features.

22. The superconducting magnet structure according to claim 20, wherein the embossed raised features are formed on a surface of the superconducting wire that is wound into an axially-directed position, the gaps being radially-directed and are formed between windings of each one of the superconducting and between the embossed raised features.

23. The superconducting magnet structure according to claim 20, wherein the superconducting wire is part-lapped with an insulating material tape, and
wherein the gaps are provided between turns of the insulating material tape.
